(19) United States
(12) Patent Application Publication
(10) Pub. No.: US 2017/0026829 A1
(43) Pub. Date: Jan. 26, 2017

(54) ADVANCED METERING INFRASTRUCTURE NETWORK SYSTEM AND MESSAGE BROADCASTING METHOD

(71) Applicant: Institute For Information Industry, Taipei (TW)

(72) Inventors: Sung-Ming YEN, Taipei City (TW); Jheng-Hong TU, Kaohsiung City (TW); Jui-Ming WU, New Taipei City (TW); You-Lian HUANG, Taoyuan City (TW)

(21) Appl. No.: 15/286,506

(22) Filed: Oct. 5, 2016

Related U.S. Application Data
(62) Division of application No. 13/714,676, filed on Dec. 14, 2012.

(30) Foreign Application Priority Data
Dec. 11, 2012 (TW) 101146586

(51) Int. Cl. H04W 12/02; H04W 12/04; H04L 9/08

(52) U.S. Cl. CPC H04W 12/02; H04L 9/0819; H04W 12/04; H04L 2209/24; H04L 2209/80

(57) ABSTRACT

An advanced metering infrastructure (AMI) server, an AMI network node, an AMI network system and a message broadcasting method thereof are provided. The AMI server generates a broadcasting key from a broadcasting message through a hash function, encrypts the broadcasting message into an encrypted broadcasting message via the broadcasting key, encrypts the broadcasting key into an encrypted key via a symmetric key, and transmits the encrypted broadcasting message and the encrypted key to the AMI network node. The AMI network node decrypts the encrypted key into the broadcasting key via the symmetric key, decrypts the encrypted broadcasting message into the broadcasting message via the broadcasting key, and processes the broadcasting message after determining that the broadcasting message corresponds to the broadcasting key through the hash function.

### PRIORITY

This application is a divisional of U.S. patent application Ser. No. 13/714,676, filed Dec. 14, 2012, which claims priority to Taiwan Patent Application No. 101146586, filed on Dec. 11, 2012, and both of which are hereby incorporated herein by reference in their entirety.

### FIELD

The present invention relates to an advanced metering infrastructure (AMI) server, an AMI network node, an AMI network system and message broadcasting methods thereof. More particularly, the present invention relates to secure and quick message broadcasting methods for an AMI server, an AMI network node and an AMI network system.

### BACKGROUND

An advanced metering infrastructure (AMI) mainly consists of a meter data management system (MDMS) and smart meters, and transmits messages through a communication network to manage and control electricity-related information. Similar to common networks, security of message transmissions must be taken into consideration in order to guarantee correctness of contents of the network messages. Key systems are adopted the most widely for this purpose.

Specifically in a conventional AMI adopting a key system, an electricity-related control message is firstly encrypted by a key when a server terminal (e.g., an MDMS or a concentrator) is to broadcast the control message. Then, a client (e.g., a concentrator or a smart meter) decrypts the message by using the key and processes the content of the message. Likewise, the key architecture applied to the AMI also adopts a conventional key encryption approach.

However, in the AMI architecture, the server terminal and all the clients use a common key K_{C} to encrypt messages. Therefore, in case any of the clients is maliciously attacked and manipulated, the attacker will be able to encrypt erroneous messages by using the common key K_{C} directly and distribute the erroneous messages. On the other hand, if the server terminal and the individual clients in the AMI architecture all adopt conventional symmetric keys to encrypt messages, then a high security level can be achieved. However, because the number of symmetric keys that need to be stored and processed by the server is directly proportional to the number of clients, it will take the server terminal more time to encrypt broadcasting messages as the number of clients in the network increases, and this reduces the overall message transmission efficiency of the network.

Furthermore, also some conventional technologies accomplish encryption by using both a common key K_{C} and a symmetric key Kᵢ. In detail, the server terminal has both the common key K_{C} and a symmetric key Kᵢ, while a client have the symmetric key Kᵢ. The server terminal firstly uses the common key K_{C} to encrypt a network message M to obtain E_{kc}(M), and then uses the symmetric key Kᵢ to encrypt the common key K_{C} to obtain Eₖᵢ(K_{C}). Thereafter, E_{kc}(M) and Eₖᵢ(K_{C}) are concatenated together and transmitted to the client.

Then, the client can firstly use the symmetric key Kᵢ to decrypt Eₖᵢ(K_{C}) to obtain the common key K_{C}, and then uses the common key K_{C} to decrypt E_{kc}(M) to obtain the network message M. Through this mechanism, security can be improved as compared to the case where only a common key is used, and the key processing complexity can be reduced as compared to the case where only symmetric keys are used.

However, if any node is maliciously attacked and manipulated in the aforesaid mechanism, then the malicious node can still obtain the common key K_{C} by using its original symmetric key Kᵢ to decrypt Eₖᵢ(K_{C}) and further use the common key K_{C} to encrypt a malicious message M′ to obtain E_{kc}(M′). Then, the malicious node can replace E_{kc}(M) in the concatenated message with E_{kc}(M′), and transmit the modified message to other clients. This makes it impossible for the other clients to know whether the message they receive is secure. Moreover, although the aforesaid mechanism can slightly reduce the key processing complexity as compared to the case where only symmetric keys are used, the processing time spent by the server terminal in pre-processing Eₖᵢ(K_{C}) of the clients is still influenced by the number of nodes.

Accordingly, an urgent need exists in the art to provide a solution capable of transmitting messages more securely and efficiently in the AMI architecture to ensure normal and rapid operations of the AMI architecture.

### SUMMARY

To solve the aforesaid problems, the present invention provides an advanced metering infrastructure (AMI) server, an AMI network node, an AMI network system and message broadcasting methods thereof, which accomplish pairing of a network message and a symmetric key through use of a hash function and use the symmetric key to ensure correctness of the message. Meanwhile, the present invention adopts a stage-by-stage encryption scheme to accelerate the encrypting process.

To achieve the aforesaid objective, certain embodiments of the present invention provide a message broadcasting method for an advanced metering infrastructure (AMI) network system. The AMI network system comprises an AMI server and an AMI network node. The message broadcasting method comprises the following steps of: (a) enabling the AMI server to generate a broadcasting key from a broadcasting message through use of a hash function; (b) enabling the AMI server to encrypt the broadcasting message into an encrypted broadcasting message through use of the broadcasting key; (c) enabling the AMI server to encrypt the broadcasting key into an encrypted key through use of a symmetric key corresponding to the AMI network node; (d) enabling the AMI server to broadcast the encrypted broadcasting message and the encrypted key to the AMI network node; (e) enabling the AMI network node to decrypt the encrypted key into the broadcasting key through use of the symmetric key; (f) enabling the AMI network node to decrypt the encrypted broadcasting message into the broadcasting message through use of the broadcasting key; and (g) enabling the AMI network node to process the broadcasting message after determining that the broadcasting message corresponds to the broadcasting key according to the hash function.

To achieve the aforesaid objective, certain embodiments of the present invention further provide a message broadcasting method for an AMI network system. The AMI network system comprises an AMI server and an AMI network node. The AMI server uses a broadcasting key to encrypt a message transmitted to the AMI network node. The message broadcasting method comprises the following steps of: (a) enabling the AMI server to convert the broadcasting key into a first preliminary cipher text through use of a primitive key; and (b) enabling the AMI server to convert the first preliminary cipher text into an encrypted key message through use of a symmetric key corresponding to the AMI network node; (c) enabling the AMI server to broadcast the encrypted key message; (d) enabling the AMI network node to convert the encrypted key message into a second preliminary cipher text through use of the primitive key after receiving the encrypted key message; and (e) enabling the AMI network node to convert the second preliminary cipher text into the broadcasting key, which is used to decrypt an encrypted message broadcasted by the AMI server, through use of the symmetric key.

To achieve the aforesaid objective, certain embodiments of the present invention further provide an AMI network system, which comprises an AMI server and an AMI network node. The AMI server is configured to generate a broadcasting key from a broadcasting message through use of a hash function, encrypt the broadcasting message into an encrypted broadcasting message through use of the broadcasting key, encrypt the broadcasting key into an encrypted key through use of a symmetric key corresponding to the AMI network node, and broadcast the encrypted broadcasting message and the encrypted key to the AMI network node. The AMI network node is configured to decrypt the encrypted key into the broadcasting key through use of the symmetric key, decrypt the encrypted broadcasting message into the broadcasting message through use of the broadcasting key, and process the broadcasting message after determining that the broadcasting message corresponds to the broadcasting key according to the hash function.

To achieve the aforesaid objective, certain embodiments of the present invention further provide an AMI network system, which comprises an AMI network node and an AMI server. The AMI server has a broadcasting key for encrypting a message transmitted to the AMI network node. The AMI server is configured to convert the broadcasting key into a first preliminary cipher text through use of a primitive key, and convert the first preliminary cipher text into an encrypted key message through use of a symmetric key corresponding to the AMI network node. The AMI server is further configured to broadcast the encrypted key message. The AMI network node is configured to convert the encrypted key message into a second preliminary cipher text through use of the primitive key after receiving the encrypted key message, and convert the second preliminary cipher text into the broadcasting key, which is used to decrypt an encrypted message broadcasted by the AMI server, through use of the symmetric key.

With the aforesaid technical features disclosed above, the AMI server, the AMI network node, the AMI network system and the message broadcasting methods thereof can transmit network messages more securely and efficiently.

The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1A is a schematic view of an AMI network system according to a first embodiment of the present invention;

FIG. 1B is a schematic view of an AMI server according to the first embodiment of the present invention;

FIG. 1C is a schematic view of an AMI network node according to the first embodiment of the present invention;

FIG. 1D is a schematic view illustrating encryption and decryption operations of the AMI server and the AMI network node according to the first embodiment of the present invention;

FIG. 2A is a schematic view of an AMI network system according to a second embodiment of the present invention;

FIG. 2B illustrates comparisons between a quick encryption process of the second embodiment of the present invention and a conventional encryption process;

FIG. 3 is a flowchart diagram of a message broadcasting method according to a third embodiment of the present invention; and

FIG. 4 is a flowchart diagram of a message broadcasting method according to a fourth embodiment of the present invention.

### DETAILED DESCRIPTION

In the following descriptions, the present invention will be explained with reference to example embodiments thereof. However, these example embodiments are not intended to limit the present invention to any specific example, embodiment, environment, applications or particular implementations described in these embodiments. Therefore, description of these embodiments is only for purpose of illustration rather than to limit the present invention. It should be appreciated that, in the following embodiments and the attached drawings, elements unrelated to the present invention are omitted from depiction.

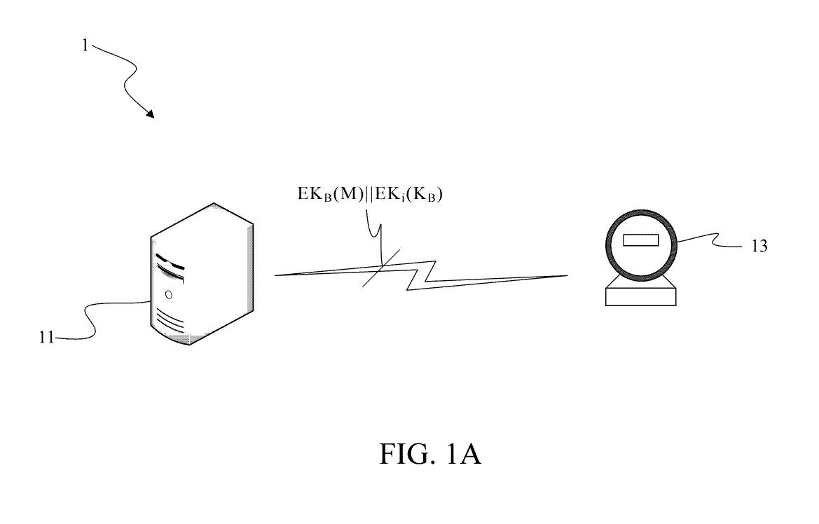

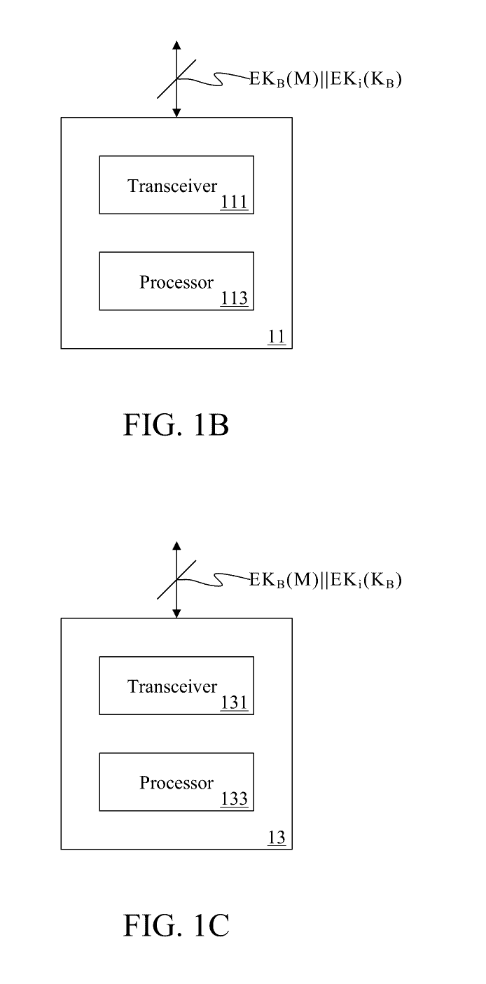

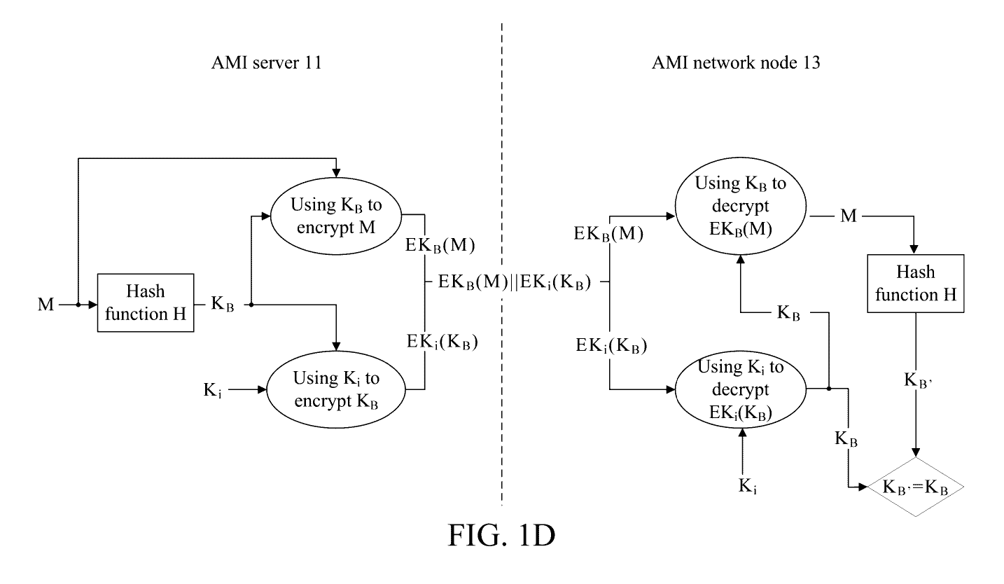

Please refer to FIG. 1A to FIG. 1C. FIG. 1A is a schematic view of an advanced metering infrastructure (AMI) network system 1 according to a first embodiment of the present invention. The AMI network system comprises an AMI server 11 and an AMI network node 13. FIG. 1B is a schematic view of the AMI server 11 according to the first embodiment of the present invention. As shown therein, the AMI server 11 comprises a transceiver 111 and a processor 113. FIG. 1C is a schematic view of the AMI network node 13 according to the first embodiment of the present invention. As shown therein, the AMI network node comprises a transceiver 131 and a processor 133.

It shall be particularly appreciated that, for convenience of describing technical features of the present invention, the AMI server 11 is a concentrator and the AMI network node 13 is a smart meter in the first embodiment. However, this is not intended to limit the hardware implementations of the present invention; and those skilled in the art can readily know from the disclosures of the present invention that, when the AMI server 11 is a backhaul network server in other embodiments, the AMI network node 13 is a concentrator correspondingly. Interactions among the network components in the first embodiment will be further described hereinbelow.

Referring to FIG. 1D, there is shown a schematic view illustrating encryption and decryption operations of the AMI server 11 and the AMI network node 13 according to the first embodiment of the present invention. Firstly, the AMI server 11 needs to encrypt a message when it desires to broadcast the message. Specifically, before broadcasting a broadcast message M, the processor 113 of the AMI server 11 firstly calculates a broadcasting key K_{B} according to the broadcasting message M through use of a hash function H. Then, the broadcasting key K_{B} and the broadcasting message M will have a correspondence relationship therebetween which is derived through use of the hash function.

Next, the processor 113 of the AMI server 11 encrypts the broadcasting message M through use of the broadcasting key K_{B} to obtain an encrypted broadcasting message EK_{B}(M) and, through use of a symmetric key Kᵢ corresponding to the AMI network node 13, encrypts the broadcasting key K_{B} to obtain an encrypted key message EKᵢ(K_{B}). Then, the encrypted broadcasting message EK_{B}(M) and the encrypted key message EKᵢ(K_{B}) are concatenated by the processor 113 into a message EK_{B}(M)∥EKᵢ(K_{B}), and the resulting message is broadcasted by the transceiver 111.

After the message EK_{B}(M)∥EKᵢ(K_{B}) formed by concatenating the encrypted broadcasting message EK_{B}(M) and the encrypted key message EKᵢ(K_{B}) is received by the transceiver 131 of the AMI network node 13, the processor 133 of the AMI network node 13 decrypts the encrypted key message EKᵢ(K_{B}) into the broadcasting key K_{B} through use of the symmetric key Kᵢ, and further decrypts the encrypted broadcasting message EK_{B}(M) into the broadcasting message M through use of the broadcasting key K_{B}.

Then, the processor 133 of the AMI network node 13 can determine whether the broadcasting message M corresponds to the broadcasting key K_{B} according to the hash function so as to determine correctness of the broadcasting message M. In detail, the processor 133 of the AMI network node 13 decrypts the encrypted key message EKᵢ(K_{B}) and the encrypted broadcasting message EK_{B}(M) into the broadcasting key K_{B} and the broadcasting message M respectively, and then the processor 133 of the AMI network node 13 can generate a broadcasting key K_{B′} from the broadcasting message M through calculation according to the hash function.

If the broadcasting key K_{B′} is equal to the broadcasting key K_{B}, then it represents that the broadcasting message M does correspond to the broadcasting key K_{B}, which means that the broadcasting message M is a correct message. On the other hand, if the broadcasting key K_{B′} is unequal to the broadcasting key K_{B}, then it represents that the broadcasting message M does not correspond to the broadcasting key K_{B}, which means that the broadcasting message M might be a message that has been tampered. In this way, security of the network message transmissions can be guaranteed.

It shall be particularly emphasized, in order to enhance the strength of pairing the broadcasting message M and the broadcasting key K_{B}, a random number parameter may be incorporated in generation of the broadcasting key K_{B} in other implementations. Specifically, the processor 113 of the AMI server 11 may use a random number parameter in the calculation process of generating the broadcasting key K_{B} according to the hash function. In this way, the pairing between the broadcasting message M and the broadcasting key K_{B} will become more unpredictable due to incorporation of the random number parameter. Then, the processor 113 of the AMI server 11 can encrypt the random number and the broadcasting message M into the encrypted broadcasting message and transmit them together to the AMI network node 13 so that the AMI network node 13 can use the same random number parameter for decryption.

Accordingly, the processor 133 of the AMI network node 13 can decrypt the encrypted broadcasting message into the random number parameter and the broadcasting message M through use of the broadcasting key K_{B′} generate the broadcasting key K_{B′} through use of the random number parameter, and determine whether the broadcasting message M is correct by determining whether the broadcasting key K_{B′} is equal to the broadcasting key K_{B}. It shall be appreciated that, related applications of the key system and the random number parameter used in the first embodiment are well known to those skilled in the art, so no further description will be made thereon herein.

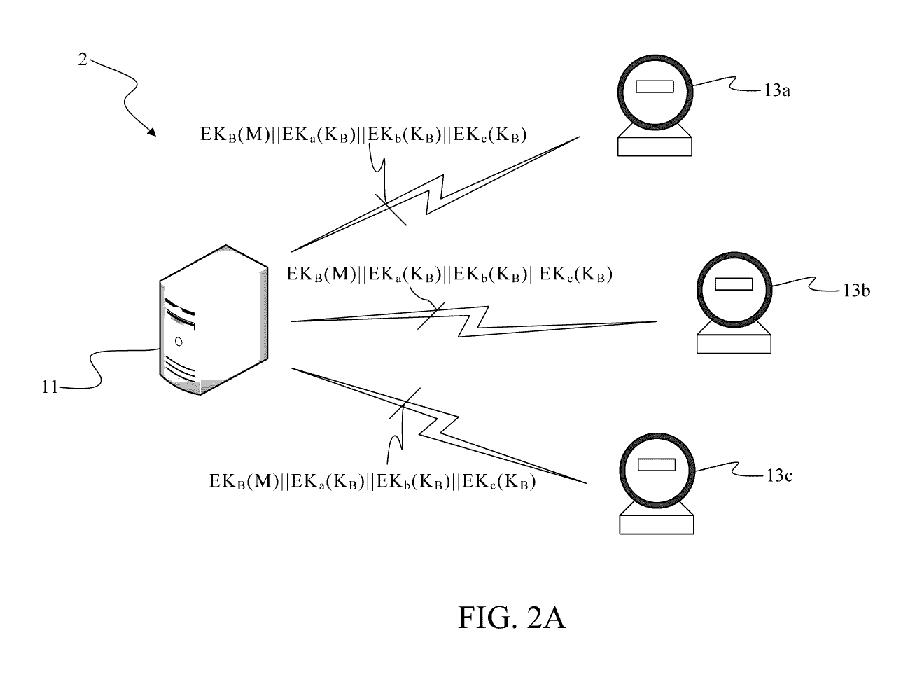

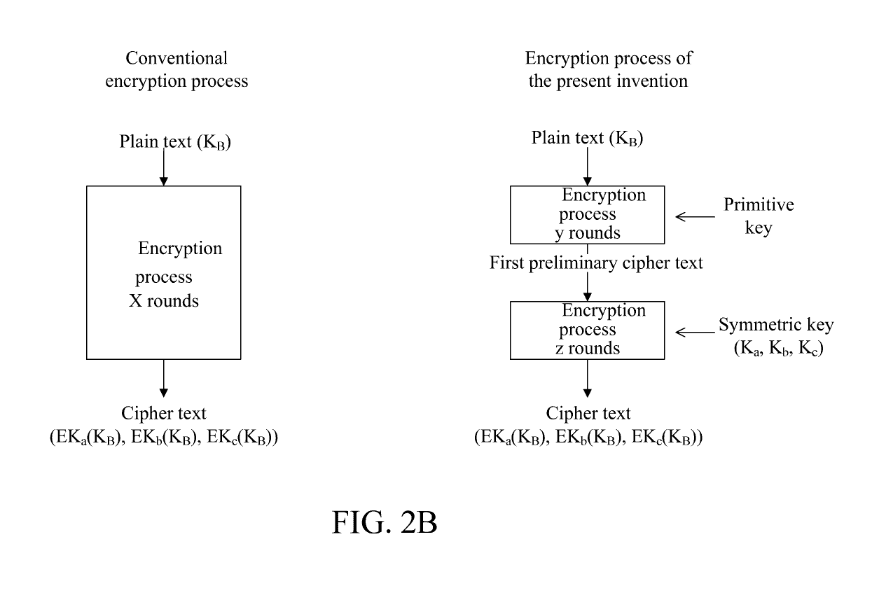

Referring to FIG. 2A, there is shown a schematic view of an AMI network system 2 according to a second embodiment of the present invention. It shall be particularly appreciated that, the system architecture and the network connection environment of the second embodiment are identical to those of the first embodiment, so components bearing the same reference numerals have the same functions and will not be further described herein. The second embodiment differs from the first embodiment in that, the second embodiment describes an implementation in which there is a plurality of AMI network nodes 13a, 13b, 13c.

Similarly in the second embodiment, the AMI server 11 needs to firstly encrypt a message when it desires to broadcast the message. Specifically, before broadcasting a broadcast message M, the processor 113 of the AMI server 11 firstly generates a broadcasting key K_{B} from a broadcasting message M through calculation by use of a hash function. Then, the broadcasting key K_{B} and the broadcasting message M will have a correspondence relationship therebetween which is derived through use of the hash function.

Next, the processor 113 of the AMI server 11 encrypts the broadcasting message M into an encrypted broadcasting message EK_{B}(M) through use of the broadcasting key K_{B}, and encrypts the broadcasting key K_{B} into encrypted key messages EKₐ(K_{B}), EK_{b}(K_{B}) and EK_{c}(K_{B}) through use of symmetric keys Kₐ, K_{b} and K_{c} corresponding to the AMI network nodes 13a, 13b and 13c respectively. Then, the encrypted broadcasting message EK_{B}(M) and the encrypted key messages EKₐ(K_{B}), EK_{b}(K_{B}) and EK_{c}(K_{B}) are concatenated by the processor 113 into a message EK_{B}(M)∥EKₐ(K_{B})∥EK_{b}(K_{B})∥EK_{c}(K_{B}), and the resulting message is broadcasted by the transceiver 111 of the processor 113.

Take the AMI network node 13a as an example. After the message EK_{B}(M)∥EKₐ(K_{B})∥EK_{b}(K_{B})∥EK_{c}(K_{B}) formed by concatenating the encrypted broadcasting message EK_{B}(M) and the encrypted key messages EKₐ(K_{B}), EK_{b}(K_{B}) and EK_{c}(K_{B}) is received by the transceiver of the AMI network node 13a from the AMI server 11, the processor of the AMI network node 13a decrypts the encrypted key message EKₐ(K_{B}) into the broadcasting key K_{B} through use of the symmetric key Kₐ, and further decrypts the encrypted broadcasting message EK_{B}(M) into the broadcasting message M through use of the broadcasting key K_{B}. Similarly, the AMI network nodes 13b, 13c can also obtain the broadcasting message M through use of symmetric keys Kₐ and K_{b} respectively.

Then, in the way detailed in the first embodiment, the processor of each of the AMI network nodes 13a, 13b and 13c can determine whether the broadcasting message M corresponds to the broadcasting key K_{B} according to the hash function respectively so as to determine correctness of the broadcasting message M. In detail, if the broadcasting key K_{B′} is equal to the broadcasting key K_{B}, then it represents that the broadcasting message M does correspond to the broadcasting key K_{B}, which means that the broadcasting message M is a correct message. On the other hand, if the broadcasting key K_{B′} is unequal to the broadcasting key K_{B}, then it represents that the broadcasting message M does not correspond to the broadcasting key K_{B}, which means that the broadcasting message M might be a message that has been tampered.

On the other hand, conventional key encryption approaches such as Data Encryption Standard (DES) or Advanced Encryption Standard (AES) all use a same symmetric key to perform many rounds of data bit adjustment on a message. In other words, if the AMI server uses a plurality of symmetric keys to encrypt the broadcasting key when there is a plurality of AMI network nodes, then the time consumed will be considerable. Therefore, in other embodiments, the overall speed of encryption and data transmission can be increased by accelerating the calculation speed of encrypted key messages.

Referring to FIG. 2B together, comparisons between a quick encryption process of the second embodiment of the present invention and the conventional encryption process are illustrated therein. Specifically, the conventional encryption process must repeat the complete (X-rounds of bit adjustment operation) encryption procedure each time a key of a different network node is encrypted. In comparison, the present invention mainly divides the conventional complete procedure into two stages (y rounds of bit adjustment operation plus z rounds of bit adjustment operation).

In more detail, during the process of encrypting the broadcasting key K_{B} into an encrypted key message, the processor 111 of the AMI server 11 firstly converts the broadcasting key K_{B} into a first preliminary cipher text through use of a primitive key (this corresponds to the y rounds of bit adjustment operation); and then the processor 111 of the AMI server 11 converts the first preliminary cipher text into encrypted key messages EKₐ(K_{B}), EK_{B}(K_{B}) and EK_{c}(K_{B}) through use of the symmetric keys Kₐ, K_{b} and K_{c} corresponding to the AMI network nodes 13a, 13b and 13c respectively (this corresponds to the z rounds of bit adjustment operation).

On the other hand, taking the AMI network node 13a as an example, the processor of the AMI network node 13a can firstly convert the encrypted key messages EKₐ(K_{B}) into a second preliminary cipher text through use of the primitive key, and then convert the second preliminary cipher text into the broadcasting key K_{B} through use of the symmetric key Kₐ. Similarly, the AMI network node 13b, 13c can also decrypt the encrypted key messages EK_{b}(K_{B}) and EK_{c}(K_{B}) into the broadcasting key K_{B} through a two-stage process.

Accordingly, it can be clearly known from FIG. 2B that, the conventional encryption process must repeat the complete (X-rounds of bit adjustment operation) encryption procedure each time a key of a different network node is encrypted. In compassion, the two-stage cipher text conversion process of the present invention has the following advantage: because the content of the first preliminary cipher text remains the same for different AMI network nodes, the AMI server 11 can use the first preliminary cipher text repeatedly during calculation of the encrypted key messages EKₐ(K_{B}), EK_{B}(K_{B}) and EK_{c}(K_{B}). In this way, the operational burden of the AMI server 11 in calculation of the encrypted key messages of different nodes can be greatly reduced.

If y=5 and z=5 for example, then the conventional encryption process has to perform X=10 (i.e., y+z) rounds of data bit adjustment on the message by use of a same symmetric key. Therefore, when the AMI server is to calculate encrypted key messages of three AMI network nodes, the AMI server must perform 10 rounds of data bit adjustment on the three AMI network nodes respectively. Thus, the AMI server must perform 3×10=30 rounds of data bit adjustment in total on the three AMI network nodes.

However, if the two-stage encryption process of the present invention is adopted, then the AMI server can firstly perform y=5 rounds of data bit adjustment on the message through use of the primitive key to obtain the preliminary cipher text. Then, when the AMI server is to calculate encrypted key messages of three AMI network nodes, the AMI server can directly use the preliminary cipher text, which has been subjected to 5 rounds of data bit adjustment, to perform another z=5 rounds of data bit adjustment on each of the three AMI network nodes respectively. Thus, the AMI server can provide the same encryption effect by performing only 5+5×3=20 rounds of data bit adjustment in total.

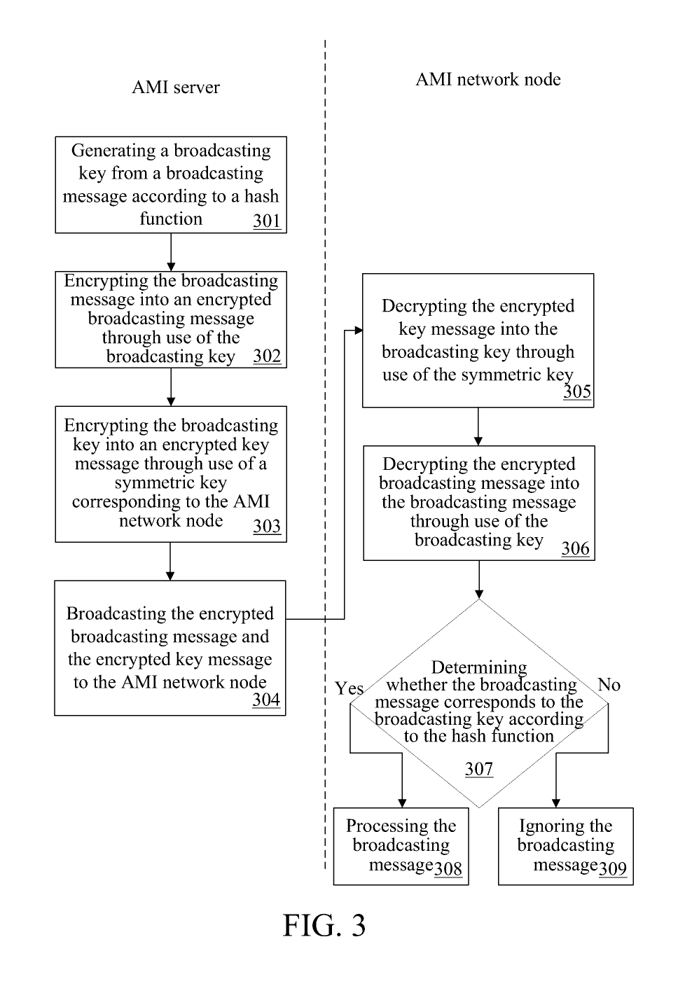

A third embodiment of the present invention is a message broadcasting method, a flowchart diagram of which is shown in FIG. 3. The method of the third embodiment is for use in an AMI network system (e.g., the AMI network system 1 of the first embodiment) as well as an AMI server and at least one AMI network node comprised in the AMI network system (e.g., the AMI server 11 and the AMI network node 13 of the first embodiment). Steps of the third embodiment will be detailed as follows.

Firstly, step 301 is executed to enable the AMI server to generate a broadcasting key from a broadcasting message through use of a hash function. Then, step 302 is executed to enable the AMI server to encrypt the broadcasting message into an encrypted broadcasting message through use of the broadcasting key, and step 303 is executed to enable the AMI server to encrypt the broadcasting key into at least one encrypted key message through use of at least one symmetric key corresponding to the at least one AMI network node. Next, step 304 is executed to enable the AMI server to broadcast the encrypted broadcasting message and the at least one encrypted key message to the at least one AMI network node. Thereafter, step 305 is executed to enable the at least one AMI network node to decrypt the at least one encrypted key message into the broadcasting key through use of the at least one symmetric key.

Then, step 306 is executed to enable the at least one AMI network node to decrypt the encrypted broadcasting message into the broadcasting message through use of the broadcasting key, and step 307 is executed to enable the at least one AMI network node to determine whether the broadcasting message corresponds to the broadcasting key according to the hash function. If the answer is “Yes”, then it represents that the broadcasting message is correct, and then step 308 is executed to process the broadcasting message; and otherwise, if the answer is “No”, then it represents that the broadcasting message might have been tampered and step 309 is executed to ignore the broadcasting message.

Likewise, in order to enhance the strength of pairing the broadcasting message M and the broadcasting key, a random number parameter may be incorporated in generation of the broadcasting key. Specifically, the AMI server may further generate the broadcasting key from the broadcasting message through use of the hash function and a random number parameter in the step 301, and encrypt the broadcasting message and the random number parameter into the encrypted broadcasting message through use of the broadcasting key in the step 302.

Accordingly, in the step 306, the at least one AMI network node can decrypt the encrypted broadcasting message into the broadcasting message and the random number parameter through use of the broadcasting key; and in the step 307, the at least one AMI network node can process the broadcasting message after determining that the broadcasting message corresponds to the broadcasting key according to the hash function and the random number parameter. Thereby, because of the random nature of the random number parameter, the pairing between the broadcasting message and the broadcasting key will become more unpredictable due to incorporation of the random number parameter.

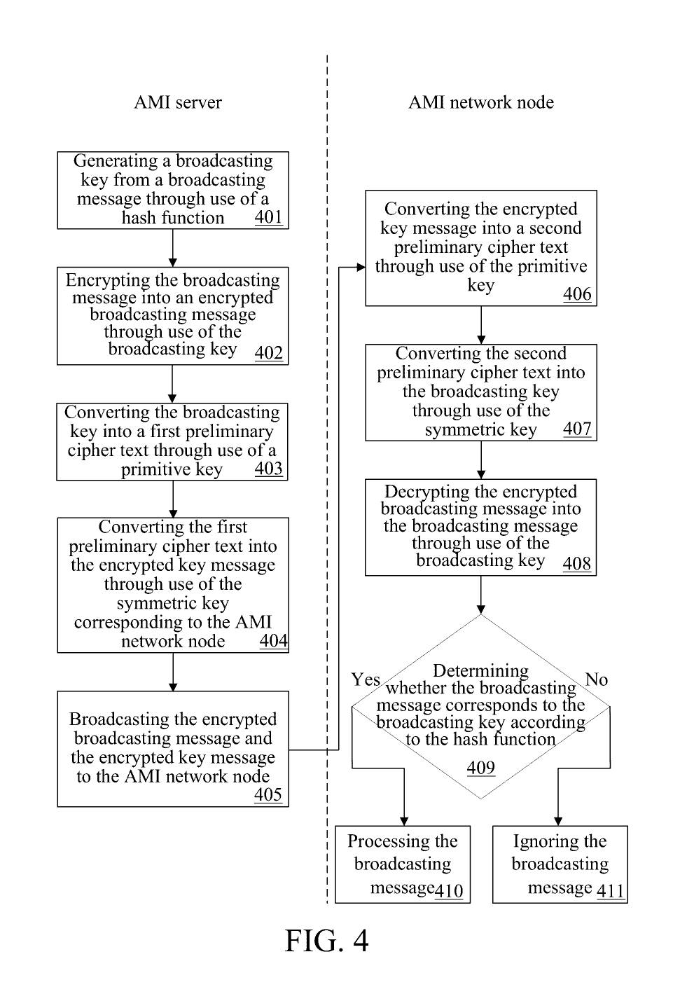

A fourth embodiment of the present invention is a message broadcasting method, a flowchart diagram of which is shown in FIG. 4. The method of the fourth embodiment is for use in an AMI network system (e.g., the AMI network system 2 of the second embodiment) as well as an AMI server and at least one AMI network node comprised in the AMI network system (e.g., the AMI server 11 and the AMI network nodes 13a, 13b, 13c of the second embodiment). Steps of the fourth embodiment will be detailed as follows.

Firstly, step 401 is executed to enable the AMI server to generate a broadcasting key from a broadcasting message through use of a hash function. Then, step 402 is executed to enable the AMI server to encrypt the broadcasting message into an encrypted broadcasting message through use of the broadcasting key, and step 403 is executed to enable the AMI server to convert the broadcasting key into a first preliminary cipher text through use of a primitive key. Next, step 404 is executed to enable the AMI server to convert the first preliminary cipher text into the at least one encrypted key message through use of the at least one symmetric key corresponding to the at least one AMI network node.

Subsequently, step 405 is executed to enable the AMI server to broadcast the encrypted broadcasting message and the at least one encrypted key message to the at least one AMI network node. Step 406 is executed to enable the at least one AMI network node to convert the encrypted key message into a second preliminary cipher text through use of the primitive key, and step 407 is executed to enable the at least one AMI network node to convert the second preliminary cipher text into the broadcasting key through use of the symmetric key.

Then, step 408 is executed to enable the at least one AMI network node to decrypt the encrypted broadcasting message into the broadcasting message through use of the broadcasting key. Step 409 is executed to enable the at least one AMI network node to determine whether the broadcasting message corresponds to the broadcasting key through use of the hash function. If the answer is “Yes”, then it represents that the broadcasting message is correct and step 410 is executed to process the broadcasting message; and otherwise, if the answer is “No”, then it represents that the broadcasting message might have been tampered and step 411 is executed to ignore the broadcasting message.

According to the above descriptions, the AMI server, the AMI network node, the AMI network system and the message broadcasting methods thereof according to the present invention can transmit network messages more securely and efficiently to ensure normal operation of the AMI network system.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A message broadcasting method for an advanced metering infrastructure (AMI) network system, the AMI network system comprising an AMI server and an AMI network node, and the AMI server using a broadcasting key to encrypt a message transmitted to the AMI network node, the message broadcasting method comprising the following steps of:
(a) enabling the AMI server to convert the broadcasting key into a first preliminary cipher text through use of a primitive key; and
(b) enabling the AMI server to convert the first preliminary cipher text into an encrypted key message through use of a symmetric key corresponding to the AMI network node;
(c) enabling the AMI server to broadcast the encrypted key message;
(d) enabling the AMI network node to convert the encrypted key message into a second preliminary cipher text through use of the primitive key after receiving the encrypted key message; and
(e) enabling the AMI network node to convert the second preliminary cipher text into the broadcasting key, which is used to decrypt an encrypted message broadcasted by the AMI server, through use of the symmetric key.

2. An advanced metering infrastructure (AMI) network system, comprising:
an AMI network node; and
an AMI server, having a broadcasting key for encrypting a message transmitted to the AMI network node;
wherein the AMI server is configured to convert the broadcasting key into a first preliminary cipher text through use of a primitive key, convert the first preliminary cipher text into an encrypted key message through use of a symmetric key corresponding to the AMI network node, and broadcast the encrypted key message; and the AMI network node is configured to convert the encrypted key message into a second preliminary cipher text through use of the primitive key after receiving the encrypted key message, and convert the second preliminary cipher text into the broadcasting key, which is used to decrypt an encrypted message broadcasted by the AMI server, through use of the symmetric key.
